(19) United States
(12) Patent Application Publication
(10) Pub. No.: US 2004/0091840 A1
(43) Pub. Date: May 13, 2004

(54) Interpretive art workbook

(76) Inventor: Sherwood Noel Wagner, Dallas, TX (US)

Correspondence Address: Monty L. Ross, Locke Liddell & Sapp LLP, Suite 2200, 2200 Ross Avenue, Dallas, TX, 75201-6776, US

(21) Appl. No.: 10/292,221

(22) Filed: Nov. 12, 2002

(51) Int. Cl. G09B 11/04; G09B 11/06

(52) U.S. Cl. 434/88

(57) ABSTRACT

An interpretative art workbook preferably having a front cover, a back cover and a plurality of sheets therebetween is disclosed herein. A set of apertures are spaced apart and positioned along an edge of each sheet, the front cover and the back cover. Preferably, a binding, such as a spiral wire is passed through the apertures of each sheet and through the apertures of each cover. The binding binds the plurality of sheets between the front cover and the back cover to form the workbook. A free-form line drawing, preferably in bold print, is displayed on each sheet. The free-form line drawing is in the form of a scribble or squiggle and is suitable for interpretation and supplementation by an individual, typically a child. The interpretive art workbook can be used as an educational or entertainment device.

### BACKGROUND OF THE INVENTION

1. Field of the Invention

The present invention relates to workbooks and more particularly to an interpretive art workbook with each sheet having a free-form line drawing suitable for interpretation and supplementation by an individual.

2. Description of Related Art

Children's coloring books, “connect the dots” drawings are well known. Devices that teach an individual how to draw are also well known in the art. Several of these devices teach by furnishing the individual with sheets illustrating incomplete representations of scenes or objects. The individual is instructed to use a writing instrument to complete the representation. For example, an educational appliance is known in the art that helps the individual develop a picture by supplying an incomplete picture in dotted or faint outline. The individual follows the dotted or faint outline with a writing instrument to create an image with continuous or bold lines. Another educational appliance known in the art supplies one-half of a sketch on one side of a page, while the remaining half of the sketch appears on the reverse side of the page. The individual is encouraged to complete the sketch by studying one side of the page and then turning the page over and drawing the missing portion from memory.

As these examples demonstrate, the individual uses little or no imagination or creativity to construct the rest of the representation. The final representation that the individual draws is predetermined based on an incomplete image or memorization. A device is therefore needed that allows the individual to use his or her imagination and creativity to construct an image that is not predetermined.

### SUMMARY OF THE INVENTION

The workbook disclosed herein desirably comprises a front cover, a back cover and a plurality of sheets therebetween. A free-form line drawing, preferably in bold print, is displayed on each sheet. The free-form line drawing is in the form of a scribble or squiggle and provides a starting point from which the user, typically a child, can create an image. The user interprets the free-form line drawing and then, based on the interpretation, uses a writing instrument to supplement the free-form line drawing to create the image.

The interpretive art workbook allows an individual to use his or her imagination and creativity to construct an image that is not predetermined based on an incomplete outline of an image or memorization. Only free-form line drawings are provided, which are subject to interpretation and supplementation as the artist wishes. The interpretive art workbook disclosed herein is convenient in that it combines a variety of free-form line drawings for the individual to interpret and supplement. The interpretive art workbook is also an educational device in that it encourages individuals, especially children, to expand their creativity and sharpen their artistic skills. The interpretive art workbook is a more stimulating alternative to coloring books and also provides entertainment to children waiting, for example, with adults in doctors offices or for food service in restaurants.

### BRIEF DESCRIPTION OF THE DRAWINGS

The invention is further described and explained in relation to the following figures of the drawings wherein:

FIG. 1 is a plan view of the closed workbook, displaying the front cover;

FIG. 2 is a side view of the closed workbook of FIG. 1;

FIG. 3 is a plan view of the workbook showing multiple sheets with a boldly printed, free-form line drawing on each sheet; and

FIG. 4 is a plan view of the workbook emphasizing one sheet with an individual's interpretation and supplementation in dashed outline.

Like reference numerals are used to describe like parts in all figures of the drawings.

### DETAILED DESCRIPTION OF THE PREFERRED EMBODIMENT

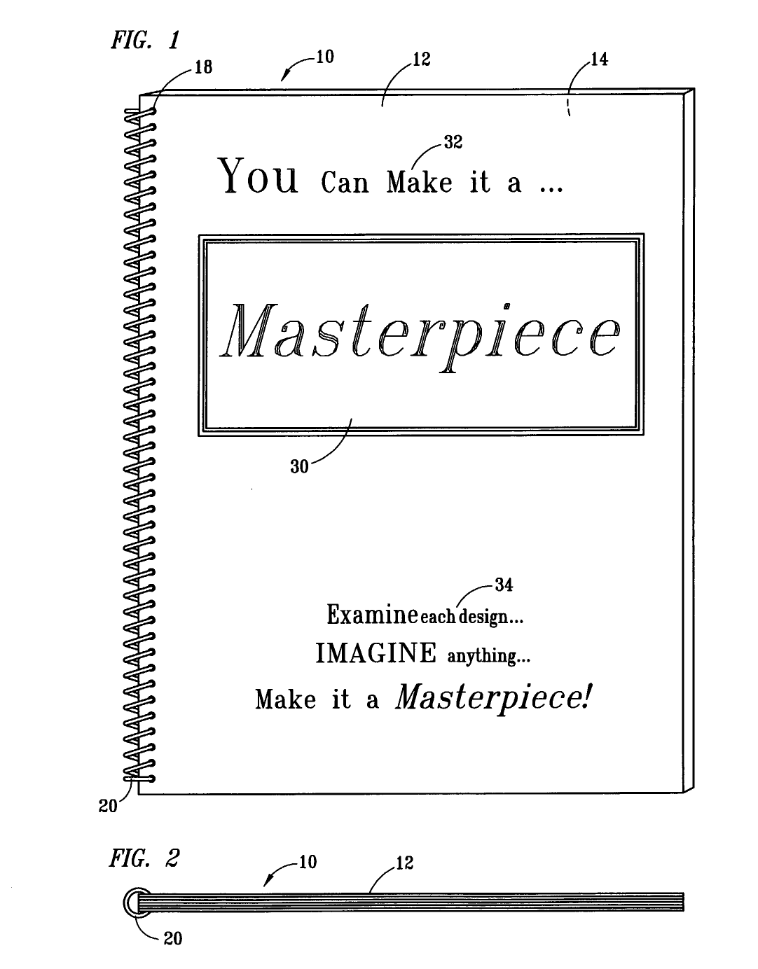

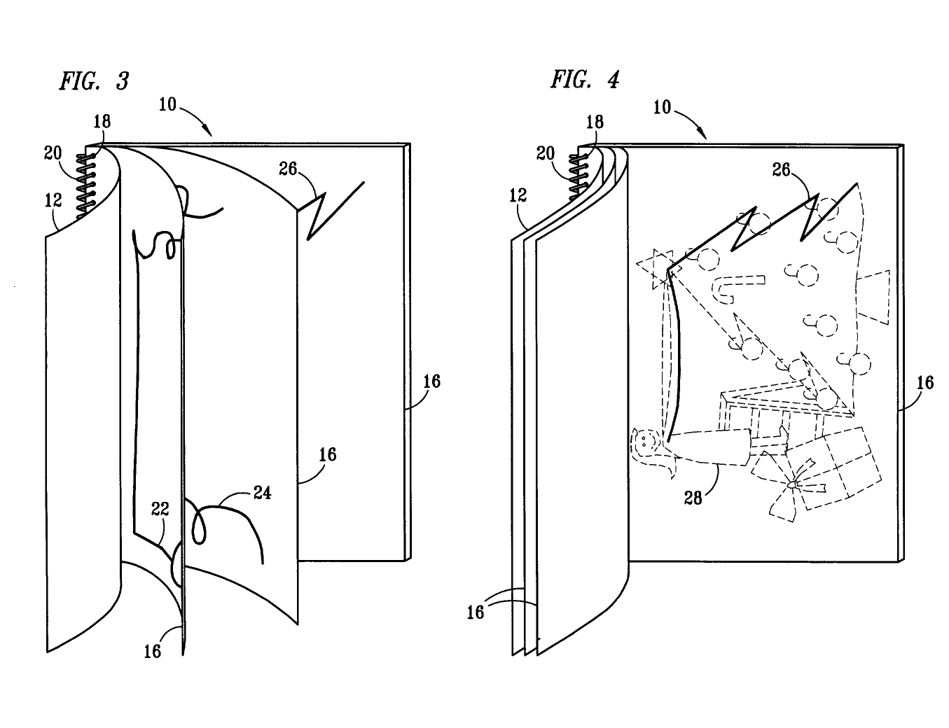

Referring to FIGS. 1-3, a workbook, designated generally by reference numeral 10, desirably comprises front cover 12, back cover 14 and a plurality of sheets 16. Sheets 16 are preferably made of paper, but can be made from plastic, laminated paper and plastic, card stock, or any other suitable material. Front cover 12 and back cover 14 are desirably made of any material that is durable enough to protect sheets 16, facilitate binding and resist tearing during use. If desired, front cover 12 can also include a title block 30, text 32 and instruction 34, although it is understood that those depicted in FIG. 1 are merely illustrative.

Preferably, a set of apertures 18 are spaced apart near the edge of front cover 12, back cover 14 and each sheet 16. Front cover 12, the plurality of sheets 16 and back cover 14 are desirably bound together by binding 20. Binding 20 is preferably a spiral wire that passes through apertures 18 near the edge of front cover 12, back cover 14 and each sheet 16. The spiral wire can be metal, polymeric or any other similar material. However, it should be understood that binding 20 is not limited to a spiral wire and can be an adhesive that adheres the plurality of sheets 16 together, fasteners, staples, binder rings or any other similar binding. It should also be understood that the plurality of sheets could be part of a kit or held in a folder with pockets.

Each sheet 16 embodies a different free-form line drawing, such as line drawings 22, 24, 26. Each free-form line drawing is in the form of a scribble or squiggle and is preferably in bold print. The individual is encouraged to use creativity and imagination to interpret the free-form line drawing. Based on that interpretation, the individual can use a writing instrument to supplement the free-form line drawing to construct a complete picture. As shown in FIG. 4, workbook 10 is opened to a particular sheet 16. The result of an individual's interpretation and supplementation of free-form line drawing 26 on the particular sheet is shown in dashed outline 28, although it will be appreciated that in actual use the image depicted by dashed outline 28 will appear as a solid line image. If desired by the artist, a portion of the resultant image can also be colored or shaded for artistic effect, using pencils, pens, crayons or the like.

Other alterations and modifications of the preferred embodiment described above will become apparent to those of ordinary skill in the art upon reading this disclosure and it is intended that the scope of the invention disclosed herein be limited only by the broadest interpretation of the appended claims to which the inventor is legally entitled.

1. An educational and entertainment device comprising:
a collection of sheets wherein each sheet has a free-form line drawing thereon suitable for interpretation and supplementation by an individual.

2. The educational and entertainment device of claim 1 wherein the collection of sheets is bound together.

3. The educational and entertainment device of claim 1 comprising a front cover.

4. The educational and entertainment device of claim 3 comprising a back cover.

5. The educational and entertainment device of claim 4 wherein the collection of sheets is bound between the front cover and the back cover.

6. The educational and entertainment device of claim 4 wherein the collection of sheets each have a set of apertures spaced apart and positioned near an edge of each sheet.

7. The educational and entertainment device of claim 6 wherein the front cover has a set of apertures spaced apart and positioned near an edge of the front cover.

8. The educational and entertainment device of claim 7 wherein the back cover has a set of apertures spaced apart and positioned near an edge of the back cover.

9. The educational and entertainment device of claim 8 comprising a binding that binds the collection of sheets, the front cover and the back cover together by passing through the apertures of each sheet, the front cover and the back cover.

10. The educational and entertainment device of claim 9 wherein the binding is a spiral wire.

11. The educational and entertainment device of claim 1 wherein the free-form line drawing is in bold print.

12. The educational and entertainment device of claim 1 wherein the sheets are made of paper.

13. A bound workbook comprising:
a front cover;
a plurality of sheets being bound to the front cover; and
a free-form line drawing on each sheet suitable for interpretation and supplementation by an individual.

14. The bound workbook of claim 13 comprising a back cover.

15. The bound workbook of claim 14 wherein the plurality of sheets are bound between and together with the front cover and the back cover.

16. The bound workbook of claim 14 wherein the plurality of sheets each have a set of apertures spaced apart and positioned near an edge of each sheet.

17. The bound workbook of claim 16 wherein the front cover has a set of apertures spaced apart and positioned near an edge of the front cover.

18. The bound workbook of claim 17 wherein the back cover has a set of apertures spaced apart and positioned near an edge of the back cover.

19. The bound workbook of claim 18 comprising a binding that binds the plurality of sheets, the front cover and the back cover together by passing through the apertures of each sheet, the front cover and the back cover.

20. The bound workbook of claim 19 wherein the binding is a spiral wire.

21. The bound workbook of claim 13 wherein the free-form line drawing is in bold print.

22. The bound workbook of claim 13 wherein the plurality of sheets are made of paper.

23. A spiral bound workbook, comprising:
a plurality of sheets of paper having a set of apertures spaced apart near an edge of each sheet of paper to receive a spiral wire therethrough;
a front cover having a set of apertures spaced apart near an edge of the front cover to receive the spiral wire therethrough;
a back cover having a set of apertures spaced apart near an edge of the back cover to receive the spiral wire therethrough;
the front cover, back cover and the plurality of sheets of paper being bound together by the spiral wire; and
a free-form line drawing on each sheet of paper suitable for interpretation and supplementation by an individual.

24. The bound workbook of claim 23 wherein the free-form line drawing is in bold print.
